(19) United States
(12) Patent Application Publication
(10) Pub. No.: US 2015/0023689 A1
(43) Pub. Date: Jan. 22, 2015

(54) PROCESS CARTRIDGE CAPABLE OF RECOVERING WASTE TONER

(71) Applicant: PRINT-RITE - UNICORN IMAGE PRODUCTS CO., LTD. OF ZHUHAI, Zhuhai, Guangdong (CN)

(72) Inventors: Wugang Tan, Zhuhai (CN); Congyu Qiu, Zhuhai (CN); Xiaofeng Yang, Zhuhai (CN); Honghui Zhou, Zhuhai (CN)

(21) Appl. No.: 14/372,676

(22) PCT Filed: Jan. 29, 2013
(86) PCT No.: PCT/CN2013/071083

§ 371 Date: Jul. 16, 2014

(30) Foreign Application Priority Data
Feb. 1, 2012 (CN) 201210022064.2

(51) Int. Cl. G03G 21/00; G03G 21/18

(52) U.S. Cl. CPC G03G 21/1814
USPC 399/111; 399/359; 399/120

(57) ABSTRACT

The present invention provides a process cartridge capable of recovering waste toner. The process cartridge comprises a toner hopper unit and a waste bin unit. The toner hopper unit comprises a waste toner recovering port and the waste bin unit comprises a waste toner discharging port. The waste toner discharging port and the waste toner recovering port are butted with each other hermetically. The waste bin unit is provided with a waste toner conveying component for conveying the waste toner within the waste bin unit to the waste toner discharging port. The entire process of recovering and reusing the waste toner is automatically carried out during normal operation of the process cartridge and thus manual operation is not needed.

### TECHNICAL FIELD OF THE INVENTION

The present invention relates to a process cartridge detachably mounted in an image forming apparatus. More particularly, the present invention relates to a process cartridge which can recover the waste toner. This application claims the priority from Chinese Patent Application No. 201210022064.2, filed on Feb. 1, 2012, titled “Process Cartridge Capable of Recovering Waste Toner”. The disclosure of which is incorporated herein by reference.

### TECHNICAL BACKGROUND OF THE INVENTION

Electrophotographic imaging forming apparatus such as laser printers, utilizing the principle of electrophotography, which at least involve charging, exposing, developing, transferring, fixing, and cleaning processes to form images on the mediums such as printing paper. Imaging forming apparatus usually use detachable process cartridges to complete the above processes.

During the charging process, a photosensitive member, such as photosensitive drum, is uniformly charged with a given amount of charge by a corona discharge method or by using a charging roller. In the exposure process, the surface of the charged photosensitive member is selectively exposed. Due to the photosensitive characteristics of the photosensitive member, the charge of the exposed region disappears by grounding. Therefore, after exposure, an electrostatic latent image is formed on the surface of the photosensitive member through the distribution of charge which corresponds to the designed image. In the developing process, the developing device, such as the developing roller, transfers the developer, such as toner, to the electrostatic latent image region with the electric force to visualize the electrostatic latent image. In the transferring process, the transferring device, such as the transfer roller, transfers the developer of the electrostatic latent image on the photosensitive member surface to an imaging medium such as paper. In the fixing process, the image fixing device firmly fixes the developer onto the imaging medium. In the cleaning process, the cleaning device, such as the cleaning blade, removes the residual developer from the surface of the photosensitive member to avoid printing defects in the next image forming cycle.

As shown in FIG. 7 and FIG. 8, in the prior art process cartridge, the toner hopper unit 1′ and the waste bin unit 2′ are independent components which are assembled together by pins. The toner hopper unit 1′ comprises a developing roller 3′, a doctor blade 4′, and an agitating frame 6′. The waste bin unit 2′ comprises a photosensitive drum 7′, a charging roller 8′, and a cleaning blade 9′. When the process cartridge is working, the residual toner on the drum surface is scraped by the cleaning blade and stored in the waste bin unit after transferring. After the toner in the toner hopper unit is exhausted, the “waste toner” stored in the waste bin unit is discarded with the process cartridge, which produces waste and adversely impacts the environment.

### DESCRIPTION OF THE INVENTION

One objective of the present invention is to overcome the above prior art deficiencies and to provide a process cartridge which can conveniently recover and reuse the waste toner.

To solve the above technical problem, the present invention provides a process cartridge which can recover the waste toner. The process cartridge comprises a toner hopper unit and a waste bin unit. The toner hopper unit has a waste toner recovering port. The waste bin unit has a waste toner discharging port. The waste toner recovering port and the waste toner discharging port are butted with each other hermetically. The waste bin unit is provided with a waste toner conveying component for conveying the waste toner within the waste bin unit to the waste toner discharging port.

Further, a gear for receiving driving force is fixed at one end of the waste toner conveying component so as to engage with other gears inside the process cartridge to receive power and drive the waste toner conveying component.

Further, a sealing member is provided between the waste toner discharging port and the waste toner recovering port to prevent the waste toner from leaking during the conveyance from the waste bin unit to the toner hopper unit.

Preferably, the sealing member may be attached to the periphery of the waste toner discharging port or the waste toner recovering port.

Preferably, the sealing member may be a sponge, felt, or foam rubber.

Preferably, the waste toner conveying member may be a screw, a spiral steel wire, or a rotating shaft with a tilted plate.

Further, a waste toner stirring frame is provided inside the waste bin unit. A gear is fixed on one end of the waste toner stirring frame; the gear is engaged with other gears inside the process cartridge to receive power and drive the waste toner stirring frame. Process cartridges with such a waste toner stirring frame can improve waste toner conveying efficiency because the stirring enable the waste toner to flow toward the waste toner conveying member.

Further, the waste toner recovering port is sealed by a sealing film which ensures that the process cartridge is sealed prior to use. Preferably, the sealing film is welded or adhered to the waste toner recovering port.

The advantageous effects of the present invention are as follows. The waste toner recovering port and the waste toner discharging port are butted with each other between the toner hopper unit and the waste bin unit, the waste toner conveying component inside the waste bin unit conveys the waste toner within the waste bin unit to the waste toner discharging port. The waste toner recycling and reusing process is automatically performed during the normal operation of the process cartridge and thus no manual operation is needed for recycling of the waste toner. Because the waste toner is reused, the frequency for replacing or adding fresh toner to the process cartridge is reduced. Therefore the present invention maximizes the protection of the environment, conserves resources, and reduces costs.

### BRIEF DESCRIPTION OF THE DRAWINGS

FIG. 1 is a perspective view of a process cartridge according to the present invention.

FIG. 2 is a cross-sectional view of the process cartridge shown in FIG. 1.

FIG. 3 is a perspective view of the process cartridge shown in FIG. 1 without showing the toner hopper unit.

FIG. 4 is a longitudinal sectional view of the structure shown in FIG. 3.

FIG. 5 is a perspective view of the process cartridge shown in FIG. 1 without showing the waste bin unit.

FIG. 6 is a longitudinal sectional view of the structure shown in FIG. 5.

FIG. 7 is a perspective view of a prior art process cartridge.

FIG. 8 is a cross-sectional view of the process cartridge shown in FIG. 7.

### EMBODIMENTS OF THE INVENTION

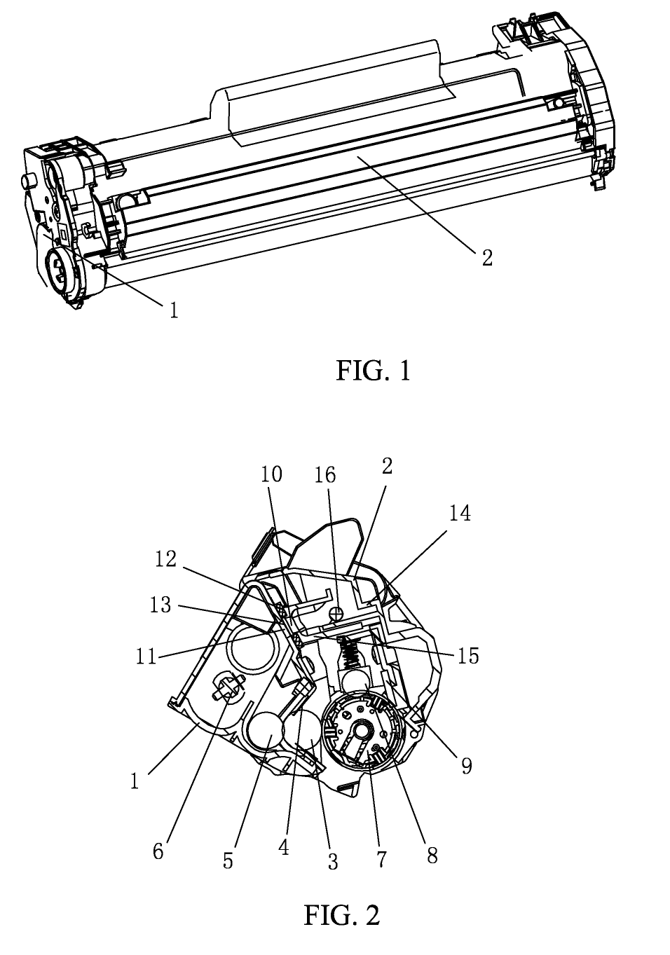

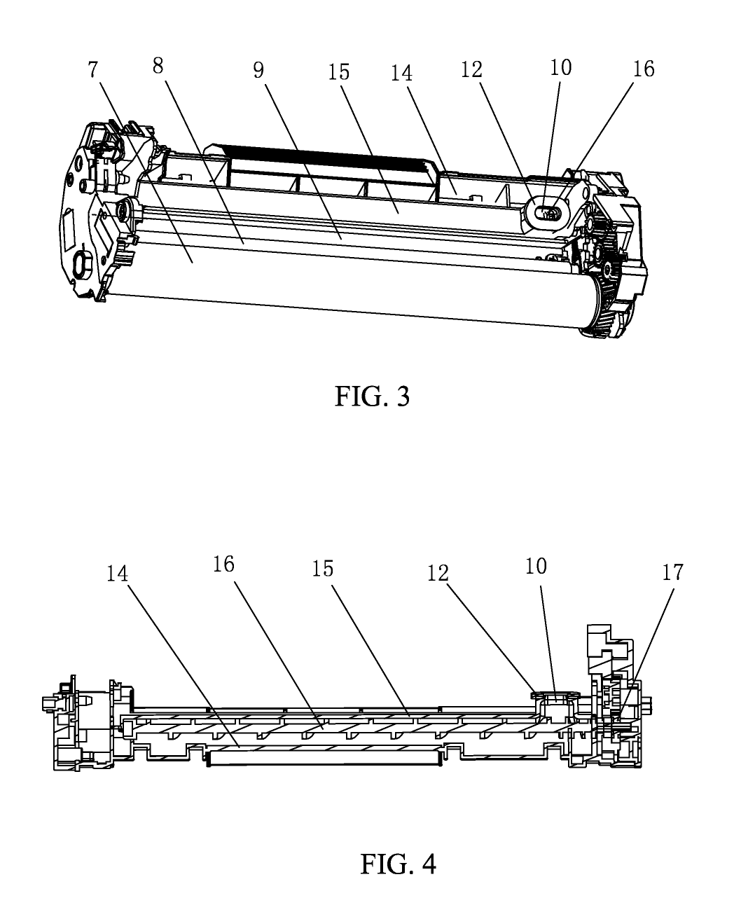

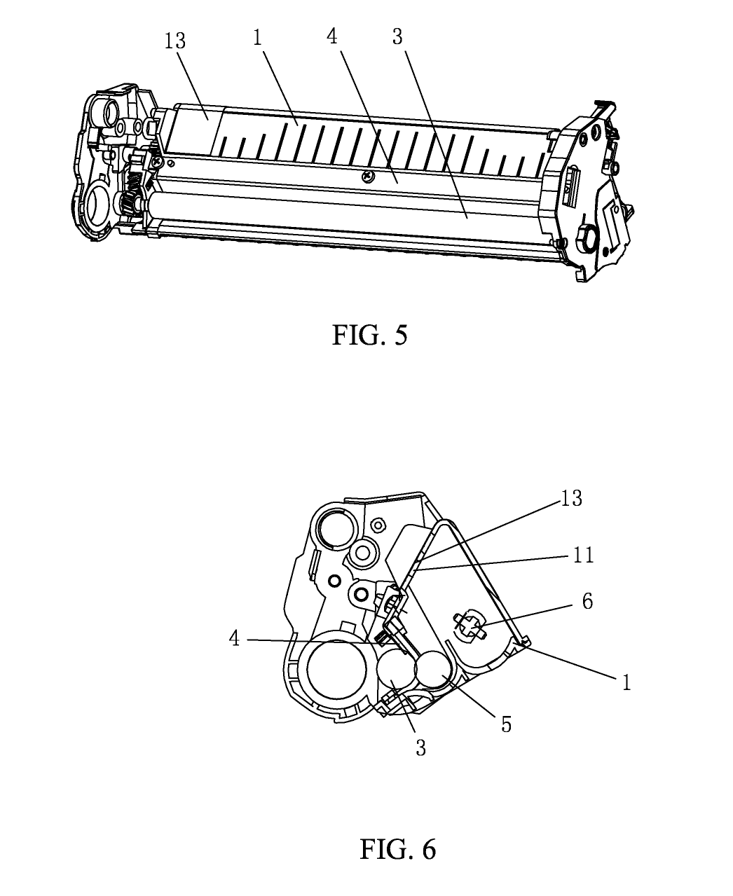

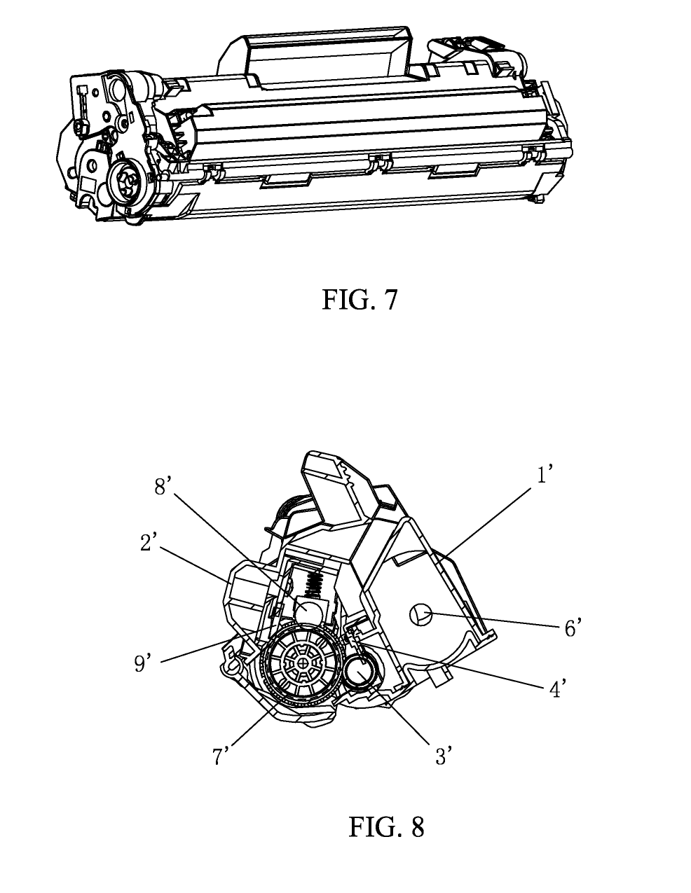

FIGS. 1-6 show a process cartridge which can recycle the waste toner. The process cartridge comprises a toner hopper unit 1 and a waste bin unit 2. The toner hopper unit 1 comprises a developing roller 3, a doctor blade 4, a toner adder roller 5 and an agitating frame 6. The waste bin unit 2 comprises a photosensitive drum 7, a charging roller 8, and a cleaning blade 9. The above structures are similar to those of the conventional process cartridges. The process cartridge of the present invention differs from the conventional process cartridge in that the waste bin unit 2 comprises a waste toner discharging port 10 and the toner hopper unit 1 comprises a waste toner recovering port 11. The waste toner discharging port 10 and the waste toner recovering port 11 are butted with each other hermetically (in a sealing way) so that the waste toner in the waste bin unit 2 can be conveyed to the toner hopper unit 1 and thus can be efficiently recycled and reused. To prevent the toner from leaking during the conveyance from the waste bin unit 2 to the toner hopper unit 1, around the waste toner discharging port 10 is attached to a sealing component 12 such as a sponge, felt or foam rubber. Also, to ensure the process cartridge is sealed before use, the waste toner recovering port 11 of the toner hopper unit 1 is sealed with a sealing film 13. The sealing film 13 is welded to the waste toner recovering port 11.

The waste bin unit 2 is formed by welding the waste bin bottom 14 with the waste bin cover 15. The waste toner discharging port 10 is located on the waste bin cover 15. The waste bin unit 2 is provided with a screw 16. Through the rotation of the screw 16, the waste toner in the waste bin unit 2 is conveyed to the waste toner discharging port 10 and then to the toner hopper unit 1 through the waste toner recovering port 11 which is butted with the waste toner discharging port 10. One end of the screw 16 is provided with a gear 17 which engages with other gears inside the process cartridge to receive power and drive the screw 16.

In a more preferred embodiment, the waste bin unit 2 is provided with a waste toner stirring frame. One end of the waste toner stirring frame is provided with a gear which engages with other gears inside the process cartridge to receive power and drive the waste toner stirring frame. The process cartridges with this structure can improve waste toner conveying efficiency because the waste toner stirring frame pushes the waste toner to flow towards the screw 16.

The assembling process of the above process cartridge is as follows. First, the screw 16 and its end sealing rings are installed on the waster bin bottom 14 (if desired, further comprising the step for installing the waste toner stirring frame), and then the waste bin cover 15 having the waste toner discharging port 10 is welded to the waste bin bottom 14. The sponge felt, the blade, the spring, the supporting frame and the gear 17 are in order mounted on the waste bin bottom 14 by following the assembling process of the existing technology. Then the cleaning blade 9, the charging roller 8, the photosensitive drum 7 and other consumable parts are installed to complete the assembly of the waste bin unit 2. For the toner hopper unit 1, the sealing film 13 is first welded on the waste toner recovering port 11, the sponge felt, the blade, the agitating frame 6 and other parts are installed on the toner hopper unit 1, and then the gears, the gear cover, the guard plate and other parts are installed to complete the assembly of the toner hopper unit 1. Finally, the waste bin unit 2 and the toner hopper unit 1 are combined with the pins to form the finished process cartridge.

Because the waste toner recovering port 11 and the waste toner discharging port 10 are butted with each other between the toner hopper unit 1 and the waste bin unit 2, and the screw 16 in the waste bin unit 2 conveys the waste toner in the waste bin unit 2 to the waste toner discharging port 10, the waste toner recycling and reusing process is automatically performed during the normal operation of the process cartridge and thus manual operation is not needed. Because the waste toner is reused, the frequency for replacing or adding fresh toner to the process cartridge is reduced, and therefore the present invention maximizes the protection of the environment, conserves resources, and reduces costs.

Of course, a person of ordinary skills in the art will recognize many variations to the present invention. For instance, the screw can be replaced by spiral steel wire or a rotating shaft having a tilted plate; the sealing component between the waste toner discharging port and the waste toner recovering port can be a felt or a foam rubber rather than a sponge; or the sealing component is attached to the waste toner recovering port rather than to the waste toner discharging port, or to both; or the sealing film is adhered rather than welded to the waste toner recovering port. All such variations will still fall within the scope of the present invention and will be protected by the claims.

### INDUSTRIAL APPLICABILITY

The process cartridge of the present invention may be commercially manufactured and used and thus possesses industrial applicability.

what is claimed is:

1. A process cartridge capable of recovering waste toner, comprising a toner hopper unit and a waste bin unit, wherein the toner hopper unit comprises a waste toner recovering port; the waste bin unit comprises a waste toner discharging port; the waste toner recovering port and the waste toner discharging port are butted with each other hermetically; and wherein the waste bin unit is provided with a waste toner conveying component for conveying the waste toner within the waste bin unit to the waste toner discharging port.

2. The process cartridge according to claim 1, wherein a gear for receiving driving force is fixed at one end of the waste toner conveying component.

3. The process cartridge according to claim 1, wherein a sealing member is provided between the waste toner discharging port and the waste toner recovering port.

4. The process cartridge according to claim 3, wherein the sealing member is attached to the periphery of the waste toner discharging port and/or the waste toner recovering port.

5. The process cartridge according to claim 3, wherein the sealing member is a sponge, a felt, or a foam rubber.

6. The process cartridge according to claim 1, wherein the waste toner conveying component is a screw.

7. The process cartridge according to claim 1, wherein the waste toner conveying component is a spiral steel wire or a rotating shaft with a tilted plate.

8. The process cartridge according to claim 1, wherein a waste toner stirring frame is provided inside the waste bin unit.

9. The process cartridge according to claim 1, wherein the waste toner recovering port is sealed with a sealing film.

10. The process cartridge according to claim 1, wherein the sealing film is welded or adhered to the waste toner recovering port.
